(19) United States
(12) Patent Application Publication
(10) Pub. No.: US 2025/0103009 A1
(43) Pub. Date: Mar. 27, 2025

(54) METHOD FOR MANUFACTURING AN ENAMELLED WATCH COMPONENT

(71) Applicant: The Swatch Group Research and Development Ltd, Marin (CH)

(72) Inventors: Lucie TABARD, Neuchatel (CN); Blaise POINSOT, Le Mont-sur-Lausanne (CH); Marta FORNABAIO, Crissier (CH); Claire MCGILL, Neuchatel (CH)

(73) Assignee: The Swatch Group Research and Development Ltd, Marin (CH)

(21) Appl. No.: 18/825,070

(22) Filed: Sep. 5, 2024

(30) Foreign Application Priority Data
Sep. 25, 2023 (EP) 23199362.7

(51) Int. Cl. G04D 3/00; G04B 19/12

(52) U.S. Cl. CPC G04D 3/0092; G04B 19/12

(57) ABSTRACT

A method for manufacturing a watch component (2) having a coloured enamelled plating (10), including the following steps: providing a substrate (20) chosen among materials capable of withstanding an enamel firing temperature; preparing (22) a coloured enamel composition constituting the coloured enamel plating of the watch component (2), the step (22) involving the encapsulation (24) of colour pigments in transparent protective shells made of inorganic material and the mixing (25) of the encapsulated colour pigments with an enamel preparation; applying (27) at least one layer of prepared coloured enamel composition to a receiving zone (8) on the substrate; and firing (28) the layer of coloured enamel composition comprised in the receiving zone (8).

### CROSS-REFERENCE TO RELATED APPLICATIONS

This application is claims priority to European Patent Application No. 23199362.7, filed on Sep. 25, 2023, the disclosures of which are incorporated by reference herein their entireties

### TECHNICAL FIELD OF THE INVENTION

The present invention relates to a method for manufacturing a watch component comprising an enamelled plating incorporating colour pigments.

The invention also relates to the watch component featuring such an enamelled plating and to a timepiece, such as a watch, comprising such a watch component.

### TECHNOLOGICAL BACKGROUND

In the field of horology, watch components comprising an enamel plating, such as enamel dials, have been known for a very long time. Such enamel dials have interesting characteristics, in that they are virtually unalterable and can be used to create decorations with an extremely bright and rich colour palette, including colour pigments containing cadmium or even selenium.

However, due to their toxicity, such colour pigments no longer meet the homologation criteria for external watch parts.

Hence, it is clear that an alternative solution to the prior art needs to be found.

### SUMMARY OF THE INVENTION

The invention aims in particular to remedy the various drawbacks of the prior art.

The invention further aims to obtain a watch component comprising an enamelled plating containing non-toxic colour pigments, in particular brightly-coloured pigments.

To this end, one aspect of the invention relates to a method for manufacturing a watch component comprising a coloured enamel plating, the method involving the following steps:
providing a substrate chosen among materials capable of withstanding an enamel firing temperature;
preparing a coloured enamel composition constituting the coloured enamel plating of said watch component, said step involving the encapsulation of colour pigments in transparent protective shells made of inorganic material and the mixing of said encapsulated colour pigments with an enamel preparation;
applying at least one layer of prepared coloured enamel composition to a receiving zone on the substrate;
firing said layer of coloured enamel composition comprised in said receiving zone.

In other embodiments:
in the encapsulation step, a process for forming a homogeneous and conforming layer of material is applied to the entire surface of each colour pigment, said material being made of a metal oxide;
the formation process is carried out using ALD technology and/or microemulsion technology;
the coloured enamel composition comprises a mass percent of at most 30% of encapsulated colour pigments;
the coloured enamel composition comprises a mass percent of at most 50% of encapsulated colour pigments;
a treatment step on said receiving zone on the substrate to which the layer of coloured enamel composition is applied, said step involving the application of degreasing and/or bonding agents to said receiving zone;
a finalisation/finishing step on the substrate provided in its zone for receiving the layer of coloured enamel composition, said step comprising stone-cutting and polishing sub-steps;
each pigment is a brightly-coloured pigment;
each colour pigment is an inorganic pigment or a non-toxic inorganic pigment.

Another aspect of the invention relates to a watch component that can be obtained using this method.

Advantageously, this watch component comprises a substrate chosen among materials configured to withstand an enamel firing temperature and on which a receiving zone comprises a coloured enamel plating including encapsulated brightly-coloured inorganic and non-toxic pigments.

Also advantageously, the watch component comprises a plating forming a decorative element.

Another aspect of the invention also relates to a timepiece comprising such a watch component.

### BRIEF DESCRIPTION OF THE FIGURES

Other features and advantages of the invention will be more clearly apparent from reading the following description of a particular embodiment of the invention, provided merely as an illustrative and non-limiting example, and from the appended figures, among which:

FIG. 1 is a schematic representation of a timepiece comprising a watch component such as a dial, provided with a coloured enamel plating, according to one embodiment of the invention, and

FIG. 2 shows a flow chart relating to a method for manufacturing a watch component such as a dial comprising the enamelled plating incorporating brightly-coloured pigments, according to one embodiment of the invention.

### DETAILED DESCRIPTION OF THE INVENTION

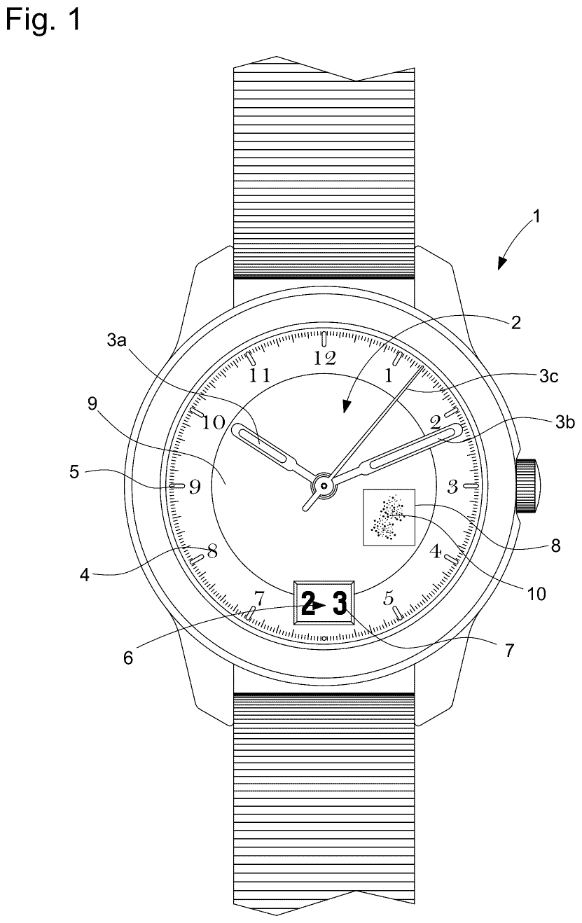

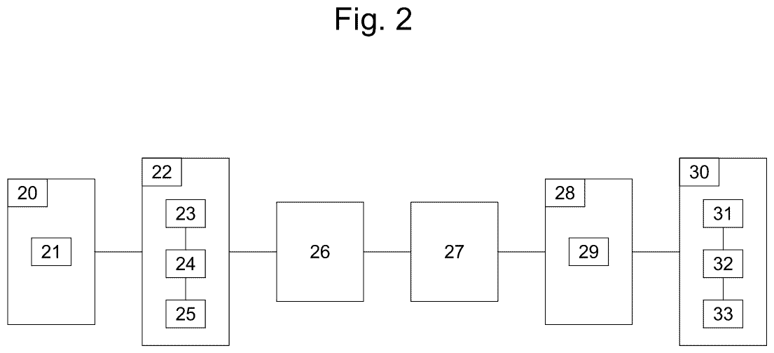

With reference to FIGS. 1 and 2, the invention relates to a method for manufacturing a watch component 2 comprising a coloured enamel plating. Such a method is used to obtain a watch component 2 for a timepiece 1, comprising a substrate provided with a receiving zone 8 including this enamelled plating incorporating brightly-coloured pigments. This receiving zone 8, comprised on the external surface of the substrate/watch component 2, can comprise all the faces of the substrate/watch component 2 or just one face or even one or more separate portions of a single face or of several different faces. Therefore, in these different variants, this plating 10 can participate in forming a decorative element on this watch component 2.

With reference to FIG. 1 and for a better understanding of the invention, the watch component 2 is in this case an external part such as a dial 2 of the timepiece 1. This dial 2 comprises, on its visible face 9, the coloured enamel plating 10 located in its receiving zone 8. However, it should be noted that this watch component 2 can alternatively be another external part such as a bezel, a moon phase, a date disc 7, a dial index, etc.

In this embodiment, the timepiece, which can be a wristwatch, comprises the analogue display dial 2, an hour hand 3a, a minute hand 3b and a seconds hand 3c which are capable of moving opposite hour markers 5 inscribed on an hour circle 4. In the example shown, the dial 2 contains an aperture 6 through the entire thickness of the dial 2, beneath which a date disc 7 moves.

In this respect, such a manufacturing method comprises a provision step 20, in which the substrate is supplied in order to form this watch component 2. Such a step 20 can comprise a blanking sub-step 21 in which the substrate is blanked in a plate to the dimensions of the watch component 2 to be manufactured; said plate can have an appropriate thickness for said component 2. This plate, and therefore this substrate, is made of a material configured to withstand enamel firing temperatures. These temperatures are preferably above 500 degrees Celsius or even comprised between 700 degrees Celsius and 1,300 degrees Celsius. As an example, this material can be metal or a metal alloy, for example steel, or even ceramic.

Such a material can also be transparent, such as a mono- or polycrystalline material like quartz, spinel or corundum, particularly sapphire. An amorphous material, such as mineral glass, can also be used, provided that its softening point is higher than the enamel firing temperature.

Next, this method comprises a preparation step 22 for a coloured enamel composition. This step 22 then comprises a production sub-step 23 for an enamel preparation. In particular, this can be a production sub-step 23 for a colourless, coloured, translucent or transparent enamel preparation. This production sub-step 23 is carried out using operating methods and preparation methods that are well known in the prior art, which will not be described in detail here, and that make it possible to obtain an enamel preparation that is colourless, coloured, translucent or transparent. It should be noted in particular that this preparation is produced using a water or oil base that is mixed with the enamel. In addition, the colourless or coloured enamel preparation is also called “initial colourless or coloured enamel composition”.

Next, this step 22 comprises an encapsulation sub-step 24 in which colour pigments are encapsulated in protective transparent shells of inorganic material, also known as “protective transparent envelopes of inorganic material”. Such a sub-step 24 involves encapsulating each pigment to be used in the coloured enamel composition in such a transparent protective shell, particularly in order to improve the thermal and/or chemical stability properties of that pigment. Indeed, this improved thermal stability enables each encapsulated pigment to retain its intact crystallographic structure when the temperature of the medium in which it is present rises to the enamel firing temperature.

Such pigments are preferably brightly-coloured or even brilliantly-coloured, such as red, yellow, orange, green, pink or even blue and variations thereof. “Bright colour” refers to an intense colour, which in the CIELAB colour space, in standard illuminant D65 transmission mode, has an observer angle of 10° and an optical geometry measured at d: 0° (conforming to standards CIE No. 15, ISO 7724/1, DIN 5033 Teil 7, ASTM E-1164) with an L* component greater than 40. It should be noted that CIELAB is a 1976 CIE L*a*b* colour space that is used in particular to characterise surface colours.

In this embodiment of the invention, these colour pigments are inorganic pigments. In particular, these pigments are non-toxic inorganic pigments. Such pigments belong, non-exhaustively and without limitation, to the (oxy) nitride family, to the cerium sulphide family or even to the phosphate family. It should be noted that pigments from the (oxy) nitride family are typically brightly-coloured, ranging from red to green and from blue to yellow. As for pigments belonging to the cerium sulphide family, they are essentially brightly-coloured, ranging from red to orange. And with regard to pigments in the phosphate family, they have bright blue, green or even purple colours.

This encapsulation sub-step 24 involves a process of forming/applying a homogeneous and conforming layer of material over the entire surface of each pigment, said material being made of a metal oxide. To do so, this material is deposited at least once on the surface to form such a layer. In this respect, the layer thus forms the protective shell encapsulating each pigment. It is understood that the cycle of depositing this material on this surface can be configured so as to obtain a given thickness of this layer. In fact, the thickness of the layer can vary according to the characteristics of the colourless enamel preparation and/or according to the characteristics of the coloured enamel plating to be applied to the watch component 2.

It is understood that such a layer is of course transparent so as not to alter the intrinsic colour of the brightly-coloured pigment.

The metal oxide that constitutes the homogeneous and conforming layer of material can be, in a non-limiting and non-exhaustive manner: a silicon dioxide with the formula SiO₂, an aluminium oxide with the formula Al₂O₃, a zinc oxide with the formula ZnO or even a titanium oxide with the formula TiO₂.

This encapsulation sub-step 24 provides that the formation of the layer and accordingly of this protective shell encapsulating each pigment can be carried out, for example, using a technology for depositing at least one atomic layer, better known by the acronym ALD for “Atomic Layer Deposition”. In the context of the invention, this technology therefore makes it possible to deposit a thin layer on the surface of each colour pigment by means of chain reactions in the gaseous phase using metal oxide precursors such as trimethylaluminium when the metal oxide is an aluminium oxide.

In one embodiment, the layer encapsulating each pigment can be formed using microemulsion technology. This technology enables a metal oxide to be deposited on the surface of the pigment by means of a microemulsion reaction using a precursor of this metal oxide. In the context of the invention, this precursor can be a tetraethyl orthosilicate when the metal oxide is silicon dioxide.

In another variant, the layer encapsulating each pigment can be formed using a combination of these two technologies. For example, this formation can, but is not limited to, start with the use of ALD technology and continue with microemulsion technology.

It is understood that such a sub-step 24 is thus used to encapsulate each pigment in a protective shell formed by the transparent layer of material that is comprised on the surface of the pigment. Such a layer is characterised by:
its homogeneity;
its conformity;
a thickness comprised between 2 nm and 1,000 nm, preferably 10 nm or preferably 30 nm or even preferably 50 nm;
its rigidity; and/or
its transparency.

It should also be noted that this layer, and therefore the shell, provides effective protection for the colour pigment against, simultaneously:
oxidation at the enamel firing temperature;
an acid medium, in particular slightly acidic with a pH ≃4.5;
exposure to ultraviolet radiation;
cosmetic agents.

The preparation step 22 of the coloured enamel composition also comprises a mixing sub-step 25 in which said encapsulated colour pigments are mixed with the colourless enamel preparation. This mixing sub-step 25 is used to obtain the coloured enamel composition in which the encapsulated colour pigments are then dispersed. In this sub-step 25, the mixture obtained, corresponding to the coloured enamel composition, comprises a mass percent of at most 30% or even at most 50% of encapsulated colour pigments.

This mass percent can preferably be comprised between 2% and 30%.

Such a mass percent can also preferably be comprised between 5% and 30%.

Such a mass percent can also preferably be comprised between 5% and 10%.

It is understood that these mass percentages of colour pigments play a part in achieving compromises in this mixture between colour, transparency and colour intensity while ensuring good final properties (for example: mechanical, homogeneity etc.).

It should also be noted that this mixture can be carried out by wet-mixing or by any other mixing method known to the person skilled in the art.

Subsequently, the method comprises a treatment step 26 on said receiving zone 8 of the substrate on which the coloured enamel plating is to be carried out. In such a step 26, degreasing and/or bonding agents can be applied to this receiving zone 8 that is intended to comprise this plating 10.

The method then comprises an application step 27 in which at least one layer of coloured enamel composition thus prepared is applied to the receiving zone 8 of the substrate. It is understood that the receiving zone 8 can, for example, be all or part of the visible face 9 of this watch component 2 when it is mounted in the timepiece 1. In this step 27, the layer of coloured enamel composition can be deposited on this receiving zone 8 by pulverisation, spraying and/or printing.

The method then comprises a firing step 28 in which said at least one layer of coloured enamel composition comprised in the receiving zone 8 of the substrate is fired. In this step, the substrate is fired at a temperature comprised between 300 degrees and 1,200 degrees, preferably between 500 degrees and 800 degrees, preferably at 690 degrees with a dwell time comprised between 1 and 10 minutes, preferably 5 minutes. This firing step 28 is carried out in open air or in a controlled atmosphere, for example under argon, nitrogen or vacuum.

It should be noted that this step 28 can involve a drying sub-step 29 in which the layer of coloured enamel composition overlying the receiving zone 8 of the substrate is dried before firing. Such a substep 29 is used to eliminate any water present in the layer prior to firing. All of the usual drying methods can be used, such as air drying, oven drying or radiation drying.

It should be noted that the sequence of application steps 27 and firing steps 28 in the method can be repeated if necessary, in order to obtain a specific or desired thickness of the coloured enamel plating on the receiving zone 8 and on the watch component 2. In this respect, the thickness depends on the number of layers that make up the coloured enamel plating 8. It is understood that this thickness is defined in particular according to the characteristics of the coloured enamel plating to be achieved on the watch component 2, in particularly its aesthetic characteristics.

The method also comprises a finalisation/finishing step 30 on the substrate provided on the receiving zone for the layer of fired coloured enamel composition in order to obtain this watch component 2 comprising the coloured enamel plating 10. This step 30 can thus include a stone-cutting sub-step 31 on this substrate and in particular on the layer of fired coloured enamel composition. This sub-step 31 can be carried out until a desired uniform thickness of the coloured enamel plating 10 is obtained. This step 30 also subsequently includes a polishing or texturing sub-step 32 in which this substrate, and in particular the layer of fired coloured enamel composition that was dulled during the stone-cutting sub-step 31, is polished or textured.

This step 30 can also include a machining sub-step 33 in order to size the substrate, if necessary, for mounting in the timepiece 1.

It should be noted that when this watch component is the dial 2, machining operations can be carried out on this dial 2 to create a through opening through which a drive axis for the hands 3a to 3c can be inserted. In this respect, applique/index creation operations can also be carried out if this has not yet been done. These appliques can be directly drawn, driven or glued on the visible face or even glued via parts running through this dial 2 by means of holes created during the machining operation.

The foregoing description relates to a preferred embodiment and should by no means be taken as limiting, particularly with regard to the type of colour pigments used for colouring the enamel. Indeed, colour pigments other than brightly-coloured ones are also part of the invention.

### Terminology

1. Timepiece
2. Watch component such as a dial
3a. Hour hand
3b. Minute hand
3c. Seconds hand
4. Hour markers
5. Hour circle
6. Aperture
7. Date disc
8. Substrate and watch component receiving zone
9. Visible face of the watch component
10. Coloured enamel coating

1. A method for manufacturing a watch component (2) comprising a coloured enamel plating (10), the method comprising the following steps:
providing a substrate (20) chosen among materials capable of withstanding an enamel firing temperature;
preparing (22) a coloured enamel composition constituting the coloured enamel plating of said watch component (2), said step (22) involving the encapsulation (24) of colour pigments in transparent protective shells made of inorganic material and the mixing (25) of said encapsulated colour pigments with an enamel preparation;
applying (27) at least one layer of prepared coloured enamel composition to a receiving zone (8) on the substrate; and
firing (28) said layer of coloured enamel composition comprised in said receiving zone (8).

2. The method according to claim 1, wherein, in the encapsulation step, a process for forming a homogeneous and conforming layer of material is applied to the entire surface of each colour pigment, said material being made of a metal oxide.

3. The method according to claim 1, wherein a process for forming a homogeneous and conforming layer of material is applied to the entire surface of each colour pigment, said material being made of a metal oxide, this process being carried out using ALD technology and/or microemulsion technology.

4. The method according to claim 1, wherein the coloured enamel composition comprises a mass percent of at most 30% of encapsulated colour pigments.

5. The method according to claim 1, wherein the coloured enamel composition comprises a mass percent of at most 50% of encapsulated colour pigments.

6. The method according to claim 1, comprising a treatment step (26) on said receiving zone on the substrate to which the layer of coloured enamel composition is applied, said step (26) involving the application of degreasing and/or bonding agents to said receiving zone.

7. The method according to claim 1, comprising a finalisation/finishing (30) step on the substrate provided in its zone for receiving (8) the layer of coloured enamel composition, said step (30) comprising stone-cutting (31) and polishing (32) sub-steps.

8. The method according to claim 1, wherein each pigment is a brightly-coloured pigment.

9. The method according to claim 1, wherein each colour pigment is an inorganic pigment or a non-toxic inorganic pigment.

10. A watch component (2) that can be obtained using the method according to claim 1.

11. The watch component (2) according to claim 10, comprising a substrate chosen among materials configured to withstand an enamel firing temperature and on which a receiving zone (8) comprises a coloured enamel plating including encapsulated brightly-coloured inorganic and non-toxic pigments.

12. The watch component (2) according to claim 10, comprising a substrate chosen among materials configured to withstand an enamel firing temperature and on which a receiving zone (8) comprises a coloured enamel plating including encapsulated brightly-coloured inorganic and non-toxic pigments wherein said plating (8) forms a decorative element.

13. A timepiece (1) comprising a watch component (2) according to claim 10.
